(19) United States
(12) Patent Application Publication
(10) Pub. No.: US 2020/0380861 A1
(43) Pub. Date: Dec. 3, 2020

(54) Ambulance Controlled Traffic Lights

(71) Applicant: Wei Liu, Memphis, TN (US)

(72) Inventor: Wei Liu, Memphis, TN (US)

(21) Appl. No.: 16/425,335

(22) Filed: May 29, 2019

(51) Int. Cl. G08G 1/087

(52) U.S. Cl. CPC G08G 1/087

(57) ABSTRACT

This invention is to let ambulances (police vehicles, fire engines, or other emergency vehicles) control the traffic lights ahead on the desired paths of such vehicles, so that other vehicles will be directed accordingly to create the best possible chance of open traffic lanes for such vehicles to pass through the junction.

### CROSS-REFERENCE TO RELATED APPLICATIONS

None

### STATEMENT REGARDING FEDERALLY SPONSORED RESEARCH OR DEVELOPMENT

This is solely my personal invention and is NOT made with or related to federal funding

### REFERENCE TO A “SEQUENCE LISTING”

None

### BACKGROUND OF THE INVENTION

Frequently I have seen ambulances rush through traffic junctions and other vehicles have to swirl into the other lanes to provide enough for the ambulances to pass through, and I have decided to discover a way to allow the ambulances easily pass through the junction with the minimum efforts from other vehicles.

### BRIEF SUMMARY OF THE INVENTION

This invention is to let ambulances (police vehicles, fire engines, or other emergency vehicles) control the traffic lights ahead on the desired paths of such vehicles, so that other vehicles will be directed accordingly to create the best possible chance of open traffic lanes for such vehicles to pass through the junction.

### BRIEF DESCRIPTION OF DRAWINGS

No drawing is necessary and thus not provided herein.

### DETAILED DESCRIPTION OF THE INVENTION

This invention is to let ambulances (police vehicles, fire engines, or other emergency vehicles) control the traffic lights ahead based on the desired paths of such vehicles, so that other vehicles will be directed accordingly to create the best possible chance of open traffic lanes for such vehicles to pass through the junction.

This electronic traffic control can be achieved either by direct telecommunication between those afore-mentioned vehicles installed with electronic signal devices and the traffic lights equipped with electronic signal receivers, or by telecommunication between a central station with real-time geo information of the above-mentioned vehicles and the traffic lights equipped with electronic signal receivers.

This is to claim the idea of letting ambulances (police vehicles, fire engines, or other emergency vehicles) control the traffic lights on the desired path of such vehicles, so that other vehicles will be directed according to create the best possible chance of open traffic lanes for such vehicles to pass through.

This is also to claim that such traffic control can be achieved either by direct telecommunication between those afore-mentioned vehicles installed with electronic signal devices and the traffic lights equipped with electronic signal receivers, or by telecommunication between a central station with real-time geo information of the above-mentioned vehicles and the traffic lights equipped with electronic signal receivers.
